(19) United States
(12) Patent Application Publication
(10) Pub. No.: US 2023/0256900 A1
(43) Pub. Date: Aug. 17, 2023

(54) METHODS AND SYSTEMS FOR AN AUTOMOTIVE VEHICLE TO INDICATE THE AUTOMOTIVE VEHICLE IS ABOUT TO EXECUTE A U-TURN

(71) Applicant: Praxis International, LLC, Aurora, CO (US)

(72) Inventor: Christopher Postle, Aurora, CO (US)

(21) Appl. No.: 16/906,591

(22) PCT Filed: Jun. 19, 2020
(86) PCT No.: PCT/US2020/038599

§ 371 Date: Jun. 19, 2020

Related U.S. Application Data
(60) Provisional application No. 62/864,423, filed on Jun. 20, 2019.

(51) Int. Cl. B60Q 1/34

(52) U.S. Cl. CPC B60Q 1/343

(57) ABSTRACT

A system for an automotive vehicle to indicate the automotive vehicle is about to execute a u-turn includes an external signaling device configured to signal a u-turn. A method for an automotive vehicle to indicate the automotive vehicle is about to execute a u-turn comprises externally signaling a u-turn.

### BACKGROUND

The present application relates to methods and systems for an automotive vehicle to indicate the automotive vehicle is about to execute a u-turn.

Automotive vehicles such as cars (coupe, sedan), station wagons, sport utility vehicles (SUV), motorcycles, etc. are usually equipped with signals to indicate to other drivers what maneuver the driver of the vehicle is performing or about to perform. For example, cars usually include turn signals to indicate to other drivers which direction the car is turning and brake lights to indicate the car is stopping. These signal improve safety.

### BRIEF SUMMARY OF THE INVENTION

Cars make u-turn maneuvers in which they turn 180 degrees around and drive in a direction opposite the previous direction. A u-turn maneuver is different from a simple left or right turn and may potentially be just as dangerous or even more so. Yet, automotive vehicles are not conventionally equipped with any signals that would communicate to other drivers that the vehicle is about to perform a u-turn maneuver.

The invention disclosed herein provides such signal to communicate to other drivers that the automotive vehicle is about to perform a u-turn. These and other advantages of the invention will become apparent when viewed in light of the accompanying drawings, examples, and detailed description.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a rear of a vehicle that includes an external u-signaling device.

FIG. 2 illustrates a front of a vehicle that includes an external u-signaling device.

### DETAILED DESCRIPTION

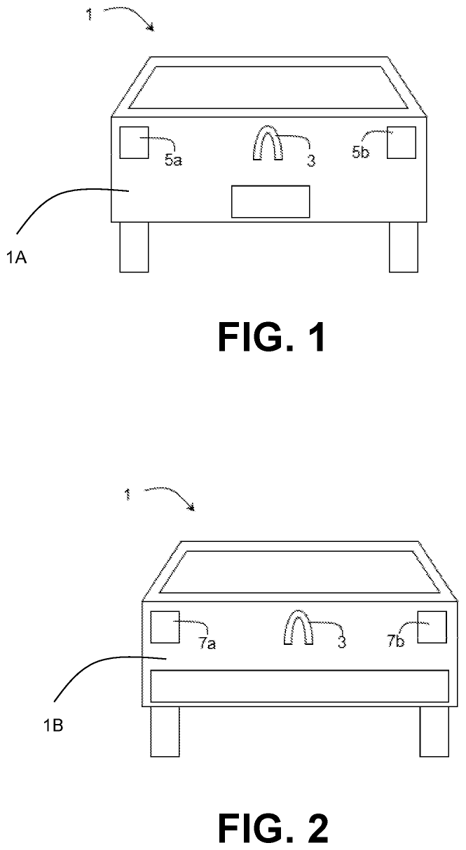

FIGS. 1 and 2 illustrate a vehicle 1. FIG. 1 illustrates a rear 1A of the vehicle 1 while FIG. 2 illustrates a front 1B of the vehicle 1. In exemplary reference to FIGS. 1 and 2, a method for an automotive vehicle 1 to indicate that it is about to execute a u-turn may include externally signaling a u-turn. Thus, a system for the automotive vehicle 1 to indicate it is about to execute a u-turn may include an external signaling device 3 configured to signal a u-turn.

In the illustrated embodiment, the external signaling device 3 is a u-turn signal light that emits light when operated by a driver or passenger of the vehicle 1. In the illustrated embodiment, the u-turn signal light 3 is disposed between turn signal lights 5a and 5b of the vehicle 1. In other embodiments, the u-turn signal light 3 may be adjacent the turn signal light 5a or the turn signal light 5b or both (e.g., multiple signal lights 3). In one embodiment, the u-turn signal light 3 emits a color light different from turn signal lights 5a, 5b, brake lights, and reverse lights of the vehicle 1. In one embodiment, the u-turn signal light 3 emits blue or green color light.

In one embodiment, the u-turn signal light, instead or in addition to being in between the turn signal lights 5a, 5b may correspond to one or more of the turn signal lights 5a, 5b of the vehicle 1. Thus, for example, a light 5a or 5b may be a turn signal and u-turn signal light. In one embodiment, the u-turn signal light 3, 5a, or 5b flashes light in a pattern different from a flashing pattern of turn signal lights 5a, 5b of the vehicle. Thus, while the typical turn signal may flash on and off in an even pattern (same time on and off), the u-turn signal light 3, 5a, or 5b may flash light in an uneven pattern that includes a first time interval in which the u-turn signal light emits light for a first amount of time and a second time interval in which the u-turn signal light emits light for a second amount of time longer than the first amount of time

In one embodiment, the u-turn signal light 3, 5a, or 5b flashes light in a pattern that includes a first time interval in which the u-turn signal light emits light of a first color and a second time interval in which the u-turn signal light emits light of a second color different from the first color. In one embodiment, the u-turn signal light 3, 5a, or 5b may flash light in a pattern that includes a first time interval in which the u-turn signal light emits light from a first turn signal 5a and a second time interval in which the u-turn signal light emits light from a second turn signal 5b of the vehicle 1. In this embodiment, the u-turn signal light 5a may turn on and off is an opposite pattern from that of u-turn light 5b. different from the first turn signal.

In one embodiment, the u-turn signal light corresponds to brake lights, reverse lights, or even headlights 7a, 7b of the vehicle 1. Thus, in one embodiment, the u-turn signal flashes light in a pattern that includes a first time interval in which the u-turn signal light emits light from a first brake signal light (e.g., right) of the vehicle 1 and a second time interval in which the u-turn signal light emits light from a second brake signal light (e.g., left). Similarly, in one embodiment, the u-turn signal flashes light in a pattern that includes a first time interval in which the u-turn signal light emits light from a first reverse signal light (e.g., right) of the vehicle 1 and a second time interval in which the u-turn signal light emits light from a second reverse signal light (e.g., left). In one embodiment, the u-turn signal flashes light in a pattern that includes a first time interval in which the u-turn signal light emits light from a first headlight 7a of the vehicle 1 and a second time interval in which the u-turn signal light emits light from a second 7b.

In the illustrated embodiment of FIG. 1, the u-turn signal light 3 corresponds to a signal light disposed on the rear of the vehicle and being u-shaped. In the illustrated embodiment of FIG. 2, the u-shaped u-turn signal light 3 corresponds to a signal light disposed on the front of the vehicle 1. In other embodiments, the u-turn signal light corresponds to a signal light disposed on one or more of front, rear, or side of the vehicle and being u-shaped or upside down u-shaped. Thus, the u-turn signal light 3 may be located anywhere (360°) in the vehicle 1 as long as it is visible by a driver of another vehicle or a pedestrian.

In one embodiment, externally signaling the u-turn includes signaling the u-turn by emitting a u-turn signal sound or sound pattern. In one embodiment, externally signaling the u-turn includes signaling the u-turn by mechanical movement of a device on an exterior of the vehicle.

To activate the u-turn signal, the vehicle 1 may include a control knob, stick, or switch inside the vehicle 1 to be operated by a driver or passenger. In one embodiment, the control knob or stick that also operates turn signals of the vehicle 1 may be operable to control the u-turn signal. In one embodiment, the vehicle 1 may include a dedicated u-turn signal switch inside the vehicle 1.

The u-turn signaling system of the vehicle 1 may include a controller operably connected to the u-turn signal light and the control knob, stick, switch, etc. to control the u-turn signal as described above (e.g., patterns, colors, sounds, etc.) to flash light in a pattern that includes a first time interval in which the u-turn signal light emits light from a first headlight of the vehicle and a second time interval in which the u-turn signal light emits light from a second headlight of the vehicle different from the first headlight signal.

This disclosure uses the term external signaling to indicate that the signaling may be observed by a driver of another vehicle and, thus, the signaling may be observed externally from the vehicle 1. External signaling may include lights outside of the vehicle 1 (e.g., light 3) as well as lights inside the vehicle 1, as long as they are externally visible.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components. An “operable connection,” or a connection by which entities are “operably connected,” is one by which the operably connected entities or the operable connection perform its intended purpose. An operable connection may be a direct connection or an indirect connection in which an intermediate entity or entities cooperate or otherwise are part of the connection or are in between the operably connected entities.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (3D. Ed. 1995).

1. A method for an automotive vehicle to indicate the automotive vehicle is about to execute a u-turn, comprising:
externally signaling a u-turn.

2. The method of claim 1, wherein the externally signaling the u-turn includes:
signaling the u-turn by lighting a u-turn signal light.

3. The method of claim 2, wherein the u-turn signal light:
is adjacent a turn signal light, or
is disposed between turn signal lights of the vehicle.

4. (canceled)

5. The method of claim 2, wherein the u-turn signal light emits:
a color light different from turn signal lights, brake lights, and reverse lights of the vehicle, or
blue or green color light.

6. (canceled)

7. The method of claim 2, wherein the u-turn signal light corresponds to:
one or more of turn signal lights of the vehicle,
one or more of headlights of the vehicle,
a signal light disposed on one or more of front, rear, or side of the vehicle and being u-shaped or upside u-shaped.

8. (canceled)

9. (canceled)

10. The method of claim 2, wherein the u-turn signal light flashes light:
in a pattern different from a flashing pattern of turn signal lights of the vehicle,
in a pattern that includes a first time interval in which the u-turn signal light emits light for a first amount of time and a second time interval in which the u-turn signal light emits light for a second amount of time longer than the first amount of time,
in a pattern that includes a first time interval in which the u-turn signal light emits light of a first color and a second time interval in which the u-turn signal light emits light of a second color different from the first color,
in a pattern that includes a first time interval in which the u-turn signal light emits light from a first turn signal of the vehicle and a second time interval in which the u-turn signal light emits light from a second turn signal of the vehicle different from the first turn signal,
in a pattern that includes a first time interval in which the u-turn signal light emits light from a first brake signal light of the vehicle and a second time interval in which the u-turn signal light emits light from a second brake signal light of the vehicle different from the first brake signal,
in a pattern that includes a first time interval in which the u-turn signal light emits light from a first reverse signal light of the vehicle and a second time interval in which the u-turn signal light emits light from a second reverse signal light of the vehicle different from the first reverse signal, or
in a pattern that includes a first time interval in which the u-turn signal light emits light from a first headlight of the vehicle and a second time interval in which the u-turn signal light emits light from a second headlight of the vehicle different from the first headlight signal.

11. (canceled)

12. (canceled)

13. (canceled)

14. (canceled)

15. (canceled)

16. (canceled)

17. The method of claim 1, wherein the externally signaling the u-turn includes:
signaling the u-turn by emitting a u-turn signal sound or sound pattern.

18. The method of claim 1, wherein the externally signaling the u-turn includes:
signaling the u-turn by mechanical movement of a device on an exterior of the vehicle.

19. The method of claim 1, comprising:
activating a device that causes the externally signaling the u-turn by operation of a control knob or stick that also operates turn signals of the vehicle.

20. The method of claim 1, comprising:
activating a device that causes the externally signaling the u-turn by operation of a dedicated u-turn signal switch inside the vehicle.

21. A system for an automotive vehicle to indicate the automotive vehicle is about to execute a u-turn, comprising:
an external signaling device configured to signal a u-turn.

22. The system of claim 21, wherein the external signaling device includes:
a u-turn signal light.

23. The system of claim 22, wherein the u-turn signal light is:
adjacent a turn signal light.
disposed between turn signal lights of the vehicle.

24. (canceled)

25. The system of claim 22, wherein the u-turn signal light emits:
a color light different from turn signal lights, brake lights, and reverse lights of the vehicle, or
blue or green color light.

26. (canceled)

27. The system of claim 22, wherein the u-turn signal light corresponds to:
one or more of turn signal lights of the vehicle,
one or more of headlights of the vehicle, or
a signal light disposed on one or more of front, rear, or side of the vehicle and being u-shaped or upside u-shaped.

28. (canceled)

29. (canceled)

30. The system of claim 22, comprising:
a controller operably connected to the u-turn signal light and configured to:
cause the u-turn signal light to flash light in a pattern different from a flashing pattern of turn signal lights of the vehicle,
cause the u-turn signal light to flash light in a pattern that includes a first time interval in which the u-turn signal light emits light for a first amount of time and a second time interval in which the u-turn signal light emits light for a second amount of time longer than the first amount of time,
cause the u-turn signal light to flash light in a pattern that includes a first time interval in which the u-turn signal light emits light of a first color and a second time interval in which the u-turn signal light emits light of a second color different from the first color,
cause the u-turn signal light to flash light in a pattern that includes a first time interval in which the u-turn signal light emits light from a first turn signal of the vehicle and a second time interval in which the u-turn signal light emits light from a second turn signal of the vehicle different from the first turn signal,
cause the u-turn signal light to flash light in a pattern that includes a first time interval in which the u-turn signal light emits light from a first brake signal light of the vehicle and a second time interval in which the u-turn signal light emits light from a second brake signal light of the vehicle different from the first brake signal,
cause the u-turn signal light to flash light in a pattern that includes a first time interval in which the u-turn signal light emits light from a first reverse signal light of the vehicle and a second time interval in which the u-turn signal light emits light from a second reverse signal light of the vehicle different from the first reverse signal, or
cause the u-turn signal light to flash light in a pattern that includes a first time interval in which the u-turn signal light emits light from a first headlight of the vehicle and a second time interval in which the u-turn signal light emits light from a second headlight of the vehicle different from the first headlight signal.

31. (canceled)

32. (canceled)

33. (canceled)

34. (canceled)

35. (canceled)

36. (canceled)

37. The system of claim 21, wherein the external signaling device includes:
a u-turn signal sound device configured to emit a u-turn signal sound or sound pattern.

38. The system of claim 21, wherein the external signaling device includes:
a u-turn signal mechanical device on an exterior of the vehicle that moves to indicate the u-turn.

39. The system of claim 21, comprising:
a control knob or stick that also operates turn signals of the vehicle.

40. The system of claim 21, comprising:
a dedicated u-turn signal switch inside the vehicle.
